(19) United States
(12) Patent Application Publication
(10) Pub. No.: US 2006/0032366 A1
(43) Pub. Date: Feb. 16, 2006

(54) Keyboard device with adjustable key touch sensation for an electronic musical instrument

(76) Inventor: Chun-Kuan Lin, Taipei City (TW)

Correspondence Address: CHRISTIE, PARKER & HALE, LLP, PO BOX 7068, PASADENA, CA, 91109-7068, US

(21) Appl. No.: 10/916,654

(22) Filed: Aug. 11, 2004

(51) Int. Cl. G10H 1/34; G10H 3/00

(52) U.S. Cl. 84/745

(57) ABSTRACT

A keyboard device for an electronic musical instrument includes a frame, a plurality of keys, a plurality of biasing members, a plurality of weight members, and a position-adjusting unit. The keys are mounted to the frame. Each of the keys has a front operating portion and a rear weight-mounting portion, and is tiltable from a normal rest position to a lower stop position in response to a stroking action at the front operating portion. The biasing members bias the keys toward the normal rest position. The weight members are mounted on the rear weight-mounting portions of the keys, and are movable relative to the front operating portions of the keys. The position-adjusting unit is operable so as to adjust concurrently positions of the weight members relative to the front operating portions of the keys.

### BACKGROUND OF THE INVENTION

1. Field of the Invention

The present invention relates to a keyboard device, more particularly to a keyboard device with an adjustable key touch sensation and suitable for use in an electronic musical instrument.

2. Description of the Related Art

The key touch sensation required when playing a keyboard of a musical instrument varies according to the skill of the performer. In particular, beginners play slower music such that the touch sensation is desired to be heavier, whereas skilled performers play faster music such that the touch sensation must be lighter so that the performer does not tire easily. The keyboard of a grand piano incorporates an adjustment mechanism for adjusting the key touch sensation. However, the typical adjustment mechanisms found in grand pianos are bulky and are unsuited for application to compact electronic musical instruments.

Referring to FIGS. 1 and 2, a conventional keyboard device 100 with an adjustable key touch sensation and suitable for use in an electronic musical instrument is shown to include a frame 2, a plurality of keys 1 mounted to the frame 2, a plurality of biasing members 3, and a plurality of weight members 14. Each of the keys 1 has a front operating portion 11 and a rear weight-mounting portion 12 disposed on opposite sides of a fulcrum that supports the keys 1 tiltably on the frame 2. Each of the keys 1 is thus tiltable relative to the frame 2 from a normal rest position to a lower stop position in response to a stroking action at the front operating portion 11. The biasing members 3 bias the keys 1 to the normal rest position. The rear weight-mounting portion 12 of each key 1 is formed with a series of through holes 13 along the length of the keys 1. By choosing an appropriate mass for the weight members 14 (in the form of metal pins) to be received in the different through holes 13 in the keys 1, the key touch sensation of the keyboard device 100 can be adjusted accordingly.

The aforesaid conventional keyboard device 100 is disadvantageous in that the presence of skilled personnel is required when it is desired to adjust the key touch sensation. Moreover, since the available mass for the weight members 14 and the positions of the through holes 13 are predetermined by the manufacturer, the range of adjustment of the key touch sensation is limited in actual practice. As a result, people with different levels of playing skills are unlikely to be satisfied with the same conventional keyboard device 100 in view of the above constraints, which necessitates the purchase of different electronic musical instruments to meet the demands of a number of users having varying levels of playing skills.

### SUMMARY OF THE INVENTION

Therefore, the object of the present invention is to provide a keyboard device that is suitable for use in an electronic musical instrument and that can overcome the aforesaid drawbacks associated with the prior art. Accordingly, the keyboard device of the present invention includes a frame, a plurality of keys, a plurality of biasing members, a plurality of weight members, and a position-adjusting unit. The keys are mounted to the frame. Each of the keys has a front operating portion and a rear weight-mounting portion, and is tiltable from a normal rest position to a lower stop position in response to a stroking action at the front operating portion. The biasing members bias the keys toward the normal rest position. The weight members are mounted on the rear weight-mounting portions of the keys, and are movable relative to the front operating portions of the keys. The position-adjusting unit is operable so as to adjust concurrently positions of the weight members relative to the front operating portions of the keys.

### BRIEF DESCRIPTION OF THE DRAWINGS

Other features and advantages of the present invention will be come apparent in the following detailed description of the preferred embodiments with reference to the accompanying drawings, of which:

FIG. 1 is perspective view of a conventional keyboard device of an electronic musical instrument;

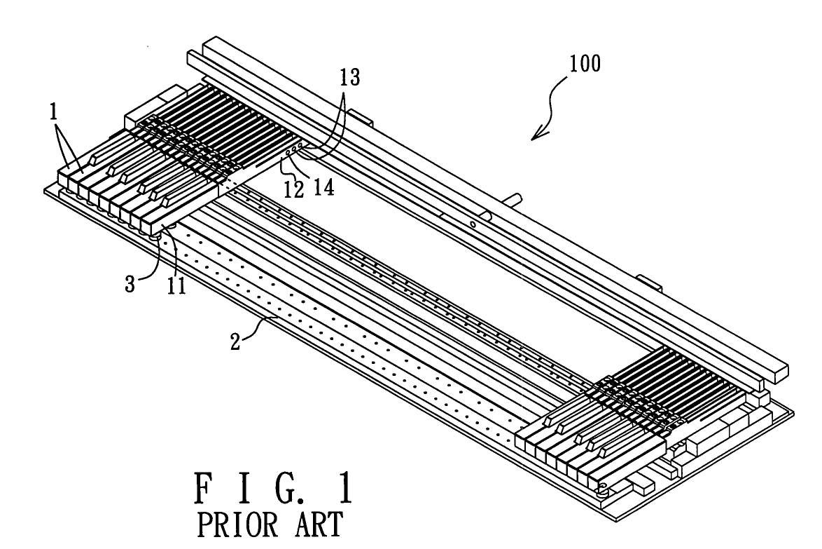

FIG. 2 is a sectional view of the conventional keyboard device of FIG. 1;

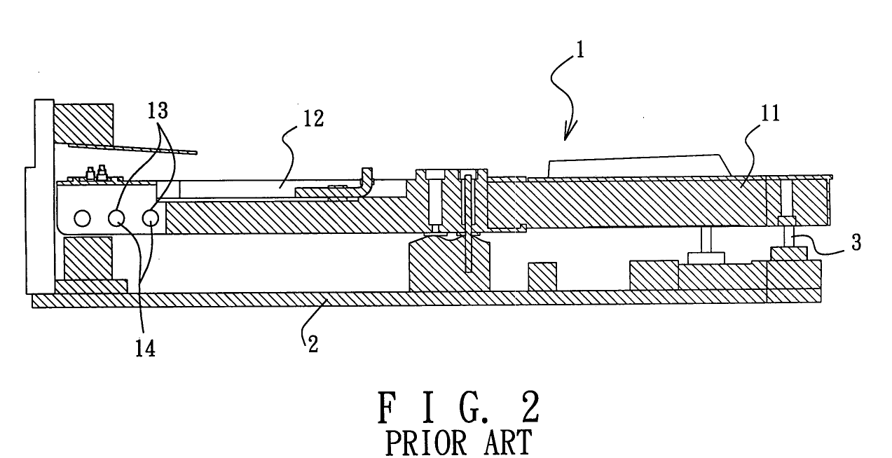

FIG. 3 is a fragmentary perspective view of the first preferred embodiment of a keyboard device of an electronic musical instrument according to the present invention;

FIG. 4 is a fragmentary schematic view of the first preferred embodiment to illustrate the relationships among keys, weight members, and a position-adjusting unit;

FIG. 5 is a fragmentary perspective view of the second preferred embodiment of a keyboard device of an electronic musical instrument according to the present invention;

FIG. 6 is a perspective view of the third preferred embodiment of a keyboard device of an electronic musical instrument according to the present invention;

FIG. 7 is a magnified view of an encircled portion found in FIG. 6; and

FIG. 8 is a fragmentary schematic view of the third preferred embodiment to illustrate the relationships among keys, weight members, and a position-adjusting unit.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

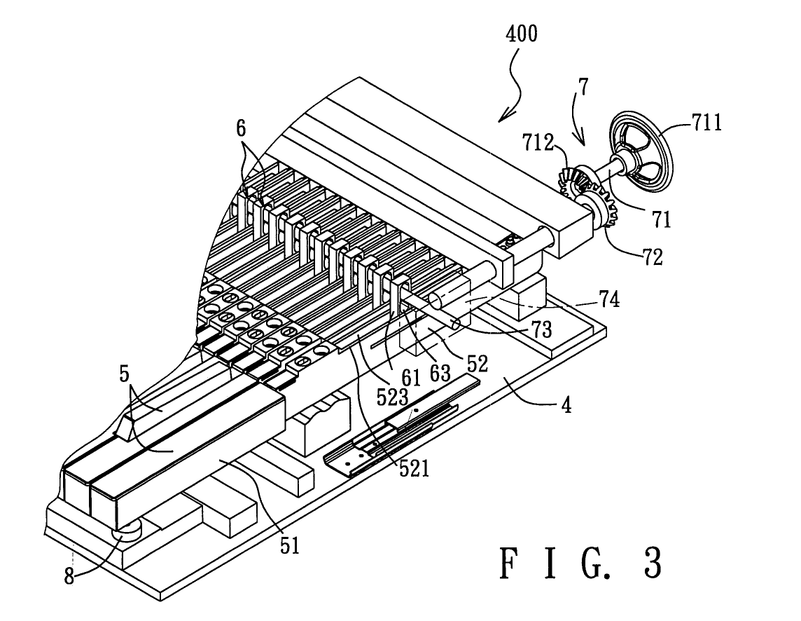

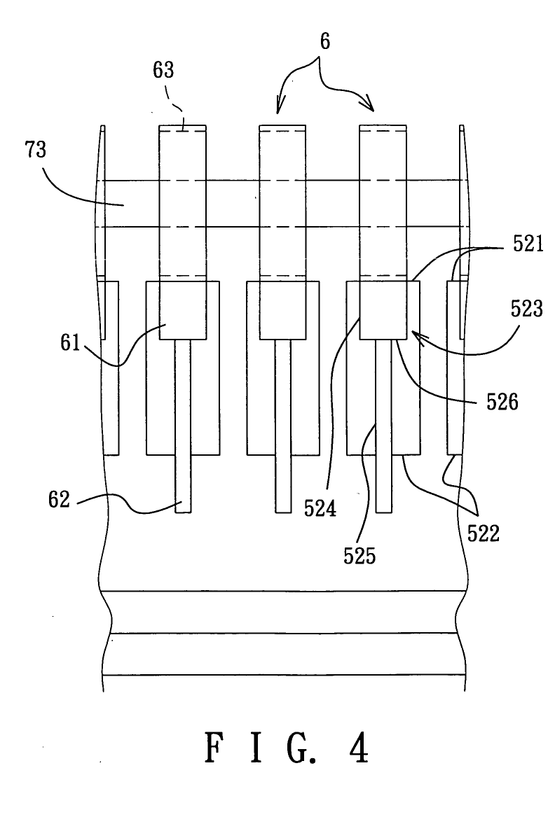

Referring to FIGS. 3 and 4, the first preferred embodiment of a keyboard device 400 according to the present invention is suitable for use in an electronic musical instrument, and is shown to include a frame 4, a plurality of keys 5, a plurality of biasing members 8, a plurality of weight members 6, and a position-adjusting unit 7.

The keys 5 are mounted to the frame 4 in a conventional manner. In particular, each of the keys 5 has a front operating portion 51 and a rear weight-mounting portion 52 disposed on opposite sides of a fulcrum that supports the keys 5 tiltably on the frame 4 in a known manner. Each of the keys 5 is thus tiltable relative to the frame 4 from a normal rest position to a lower stop position in response to a stroking action at the front operating portion 51. Each of the biasing members 8 is disposed below the front operating portion 51 of a corresponding one of the keys 5 so as to urge the front operating portion 51 away from the frame 4. The biasing members 8 thus bias the keys 5 toward the normal rest position. In this embodiment, the rear weight-mounting portion 52 of each key 5 is formed with a longitudinal slot 523 that extends from a top side 521 to a bottom side 522 of the rear weight-mounting portion 52 for receiving a respective one of the weight members 6. As shown in FIG. 4, the longitudinal slot 523 has a wider upper portion 524, a narrower lower portion 525, and a shoulder 526 at a junction of the upper and lower portions 524, 525. In practice, the shape of the longitudinal slot 523 can vary as long as it conforms to the shape of the corresponding weight member 6.

In this embodiment, each of the weight members 6 has a coupling end portion 61 and a restricted tail portion 62 extending from the coupling end portion 61. The coupling end portions 61 of the weight members 6 have upper parts formed with elongate through holes 63 that are aligned in a direction transverse to the longitudinal slots 523. When the weight members 6 are received in the longitudinal slots 523, the tail portions 62 of the weight members 6 pass through the narrower lower portions 525 of the longitudinal slots 523, lower parts of the coupling end portions 61 of the weight members 6 are seated on the shoulders 526 of the longitudinal slots 523, and the upper parts of the coupling end portions 61, which are formed with the through holes 63, are disposed above the rear weight-mounting portions 52 of the keys 5.

In this embodiment, the position-adjusting unit 7 includes an operating portion 71, a transmission portion 72, and a coupling rod 73. The operating portion 71 has an adjusting wheel 711 at one end, and a drive gear 712 at the other end. The transmission portion 72 includes a driven gear 721 that meshes with the drive gear 712, and is coupled to the coupling rod 73 via a coupling unit 74. The coupling rod 73 extends through the through holes 63 in the weight members 6 such that movement of the coupling rod 73 drives the weight members 6 to move concurrently in the same direction along the longitudinal slots 523.

In this embodiment, the through holes 63 in the weight members 6 are designed to be larger as compared to the cross-section area of the coupling rod 73 in order to prevent the coupling rod 73 from hindering upward movement of the rear weight-mounting portions 52 when the front operating portions 51 of the keys 5 are stroked. In addition, a pair of the coupling units 74 may be disposed at opposite ends of the coupling rod 73 so as to enhance stability of movement of the coupling rod 73.

Furthermore, the through holes 63 in the weight members 6 may be formed in the restricted tail portions 61 instead, which mandates disposition of the coupling rod 73 under the keys 5. In this case, the through holes 63 are also required to be larger as compared to the cross-section area of the coupling rod 73 in order to prevent the coupling rod 73 from hindering upward movement of the rear weight-mounting portions 52 when the front operating portions 51 of the keys 5 are stroked.

To adjust the key touch sensation, the adjusting wheel 711 of the operating portion 71 is rotated, thereby driving rotation of the drive and driven gears 712, 721. Due to the coupling unit 74 that interconnects the transmission portion 72 and the coupling rod 73, rotation of the transmission portion 72 results in forward or backward movement of the coupling rod 73 for adjusting concurrently positions of the weight members 6 relative to the front operating portions 51 of the keys 5.

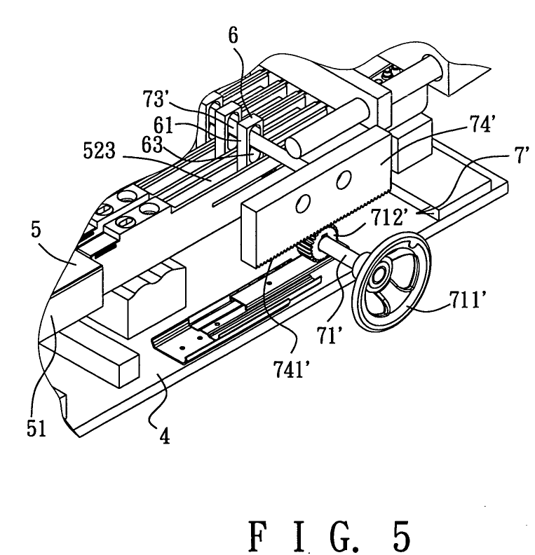

FIG. 5 illustrates the second preferred embodiment of a keyboard device of an electronic musical instrument according to the present invention. As compared to the previous embodiment, the position-adjusting unit 7′ includes an operating portion 71′, a coupling unit 74′, and a coupling rod 73′. The operating portion 71′ has an adjusting wheel 711′ at one end, and a drive gear 712′ at the other end. The coupling unit 74′ is a metal block in this embodiment, and has a toothed bottom side 741′ that meshes with the drive gear 712′. The coupling rod 73′ is connected to the coupling unit 74′ at one end, and extends through the through holes 63 in the weight members 6 such that movement of the coupling rod 73′ drives the weight members 6 to move concurrently in the same direction along the longitudinal slots 523 in the keys 5. Like the previous embodiment, a pair of the coupling units 74′ may be disposed at opposite ends of the coupling rod 73′ so as to enhance stability of movement of the coupling rod 73′. In this case, the bottom side of only one of the coupling units 74′ is required to be toothed. To adjust the keytouch sensation, the adjusting wheel 711′ of the operating portion 71′ is rotated, thereby driving rotation of the drive gear 712′. Because the coupling unit 74′ meshes with the drive gear 712′, rotation of the drive gear 712′ results in forward or backward movement of the coupling rod 73′ for adjusting concurrently positions of the weight members 6 relative to the front operating portions 51 of the keys 5.

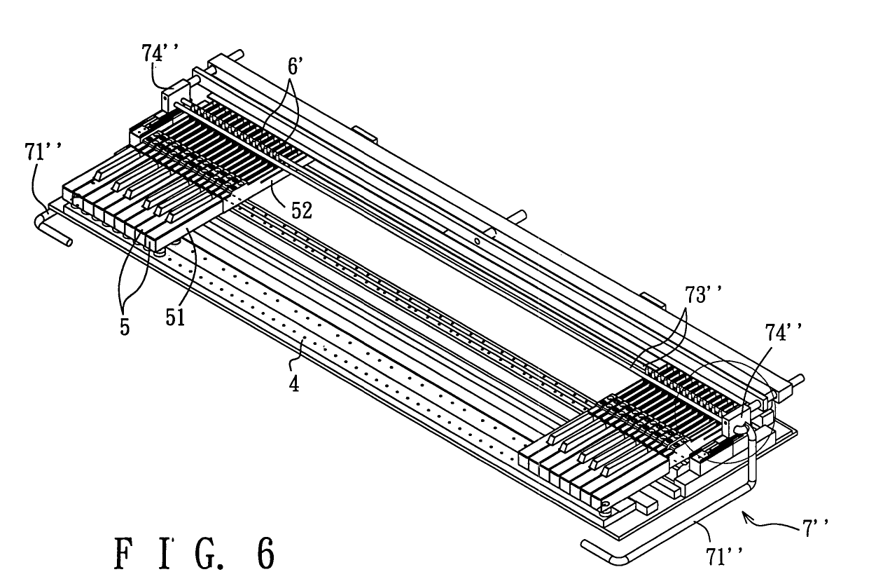

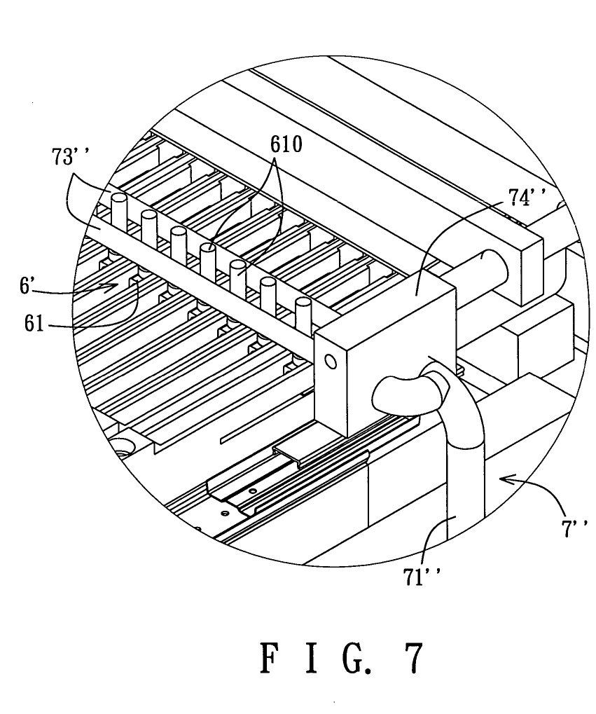

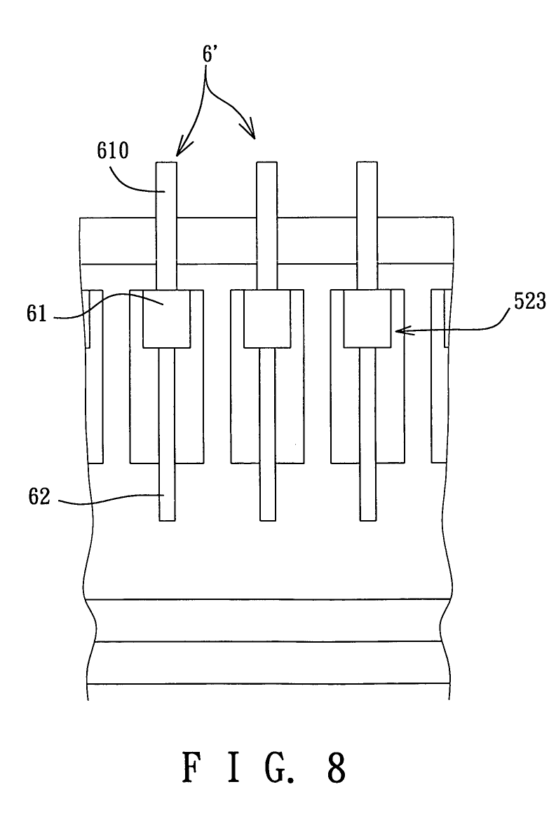

FIG. 6 to 8 illustrate the third preferred embodiment of a keyboard device of an electronic musical instrument according to the present invention. As compared to the previous embodiments, the upper parts 610 of the coupling end portions 61 of the weight members 6′ are not formed with elongate through holes, but are instead formed as diameter-reduced pin-shaped parts. Moreover, the position-adjusting unit 7″ includes a pair of operating portions 71″, a pair of coupling units 74″, and a pair of coupling rods 73″. The operating portions 71″, in the form of bent rods, are disposed on opposite ends of the keyboard device, and are connected respectively to the coupling units 74″ at one end. The operating portions 71″ further have free ends that extend forwardly relative to the front operating portions 51 of the keys 5. The coupling rods 73″ are connected to and extend between the coupling units 74″, and further have the upper parts 610 of the coupling end portions 61 of the weight members 6′ extending therebetween. As a result, movement of the coupling rods 73″ can drive the weight members 6′ to move concurrently in the same direction along the longitudinal slots 523.

To adjust the key touch sensation, the operating portions 71″ are operated to move the coupling units 74″ together with the coupling rods 73″ forward or backward, thereby adjusting concurrently positions of the weight members 6′ relative to the front operating portions 51 of the keys 5.

In yet another embodiment, the rear weight-mounting portions are connected telescopically to the front operating portions of the keys, and the weight members are fixed to the rear weight-mounting portions. In this case, by adjusting the rear weight-mounting portions through an electric position-adjusting unit, the positions of the weight members relative to the front operating portions of the keys are concurrently adjusted to adjust the key touch sensation.

It has thus been shown that, in the keyboard device of this invention, the position-adjusting unit permits concurrent adjustment of the weight members by the user in a very simple manner and without requiring the user to seek assistance from skilled personnel. Moreover, adjustment is permitted within a wide range of key touch sensations such that the electronic musical instrument that incorporates the keyboard device of this invention can meet the demands of a number of users having varying levels of playing skills.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A keyboard device of an electronic musical instrument, comprising:
a frame;
a plurality of keys mounted to said frame, each of said keys having a front operating portion and a rear weight-mounting portion, and being tiltable from a normal rest position to a lower stop position in response to a stroking action at said front operating portion;
a plurality of biasing members for biasing said keys toward the normal rest position;
a plurality of weight members mounted on said rear weight-mounting portions of said keys and movable relative to said front operating portions of said keys; and
a position-adjusting unit operable so as to adjust concurrently positions of said weight members relative to said front operating portions of said keys.

2. The keyboard device as claimed in claim 1, wherein said rear weight-mounting portion of each of said keys is formed with a longitudinal slot for receiving a respective one of said weight members.

3. The keyboard device as claimed in claim 2, wherein each of said weight members has a coupling end portion formed with a through hole, and said position-adjusting unit includes a coupling rod that extends through said through holes in said weight members.

4. The keyboard device as claimed in claim 2, wherein each of said weight members has a coupling end portion, and said position-adjusting unit includes a parallel pair of coupling rods that have said coupling end portions of said weight members extending therebetween.
